(19) United States
(12) Patent Application Publication
(10) Pub. No.: US 2003/0083975 A1
(43) Pub. Date: May 1, 2003

(54) Systems and methods for transferring ownership of an insurance asset cash flow via a true sale

(76) Inventors: Patrick O'Grady, Wicklow (IE); Caryl J. Traynor, Ottange (FR); Brian K. Weatherholtz, Glen Allen, VA (US)

Correspondence Address: BUCKLEY, MASCHOFF, TALWALKAR, & ALLISON, 5 ELM STREET, NEW CANAAN, CT, 06840, US

(21) Appl. No.: 10/016,632

(22) Filed: Oct. 30, 2001

(51) Int. Cl. G06F 17/60

(52) U.S. Cl. 705/37

(57) ABSTRACT

Systems and methods are provided for transferring ownership of an insurance asset cash flow via a legal and accounting true sale. According to one embodiment, a seller arranges to sell an insurance asset cash flow to an investor. For example, a reinsurance entity may obtain ownership of insurance receivables from an insurance company and arrange to sell the insurance receivables cash flow to a bank syndicate. The seller then transfers ownership of the insurance asset cash flow to the investor via a legal and accounting true sale. For example, the reinsurance entity may transfer all beneficial rights, title, and interest in and to the insurance receivables cash flow to the bank syndicate.

### FIELD

The present invention relates to insurance assets. In particular, the present invention relates to systems and methods for transferring ownership of an insurance asset cash flow via a legal and accounting true sale.

### BACKGROUND

An insurance company may sell insurance policies to policy holders. For example, an insurance company may promise to provide payment of a pre-determined benefit amount upon a policy holder's death in exchange for monthly premium payments. Other types of insurance policies have both an investment component and an insurance component. For example, a policy holder may provide a payment to an insurance company. The insurance company invests the payment on behalf of the policy holder (e.g., the policy holder may earn interest on the premium payment) and promises to provide an additional benefit amount upon the policy holder's death. In exchange, the insurance company may receive various forms of compensations (e.g., an administration charge).

Occasionally, an insurance company seeks to spread the risk associated with an insurance policy (or the risks associated with a pool of insurance policies) to other parties. In such a case, the insurance company may enter into a “reinsurance” transaction with another party via a separate contract. That is, the other party (the “reinsurer”) agrees to indemnify the insurance company (the “ceding” company) against all or part of the loss that the ceding company sustains under one or more insurance policies. For this service, the ceding company provides payment to the reinsurer. By spreading risk within the insurance industry, reinsurance provides the entire industry with an opportunity to function more efficiently.

Similarly, a reinsurer may seek to further spread the risk via a reinsurance of the original reinsurance transaction, known as a “retrocession” transaction. In a retrocession transaction, the reinsurer cedes business it has received for reinsurance to yet another party (e.g., another reinsurer or insurer transacting reinsurance business) via a separate contract. A retrocession transaction may be used, for example, to split up high value or problematical risks.

There are a number of disadvantages, however, with traditional approaches to reinsurance and retrocession transactions. Consider, for example, a reinsurer who provides a payment to an insurance company in exchange for certain rights associated with insurance receivables (e.g., insurance receivables that result from a pool of insurance policies). When the reinsurer later assigns certain rights associated with those insurance receivables to another investor via a retrocession transaction, the transactions are considered “on-balance sheet” for the reinsurer. That is, the reinsurer is still responsible for providing payment of the receivables to the investor, and, as a result, is required to hold capital on its books to support the payment obligation and may not be able to use a significant amount of capital for other purposes. Similarly, if the reinsurer had originally borrowed funds in order to provide payment to the insurance company, the loan remains “on the books” of the reinsurer even after the retrocession transaction—reducing the amount of additional funds that the reinsurer will be allowed to borrow. Moreover, the ongoing involvement of the reinsurer in the relationship may be viewed as a potential risk or liability.

Another disadvantage with traditional approaches to reinsurance and retrocession transactions is that an investor's only relationship is with the reinsurer. That is, the investor cannot directly assert a legal right against the insurance company. Instead, the investor can only assert the legal right (e.g., to insurance receivables) against the reinsurer, who in turn can assert its legal right against the ceding insurance company. Such an approach obviously has a number of disadvantages, including the uncertainty that will be introduced if the reinsurer becomes bankrupt. Still another disadvantage with traditional approaches relates to when various transactions will be reflected on a reinsurer's books for accounting and tax purposes (e.g., whether a transaction will be reflected in a particular fiscal year).

### SUMMARY

To alleviate problems inherent in the prior art, the present invention introduces systems and methods for transferring ownership of an insurance asset cash flow via a legal and accounting true sale.

According to one embodiment, a seller arranges to sell an insurance asset cash flow to an investor. The seller then transfers ownership of the insurance asset cash flow to the investor via a true sale.

According to another embodiment, a seller obtains ownership of a reinsurance asset from a prior owner and arranges to sell the reinsurance asset cash flow to an investor. The seller then transfers ownership of the insurance asset cash flow to the investor via a legal true sale, wherein the true sale comprises a passing, from the seller to the investor, of all beneficial rights, title and interest in and to the insurance asset cash flow. The true sale also produces an off-balance sheet result for the seller from an accounting perspective and may permit the investor to directly assert a legal right against the prior owner. In exchange for the reinsurance asset cash flow, the seller receives payment of a purchase price from the investor.

According to another embodiment, an investor arranges to purchase an insurance asset cash flow from a seller. The investor then obtains ownership of the insurance asset cash flow from the seller via a true sale.

According to still another embodiment, a seller offers to sell an insurance asset cash flow to an investor. The seller then receives from the investor an acceptance of the offer and transfers ownership of the insurance asset cash flow to the investor via a true sale.

According to yet another embodiment, a seller receives from an investor an offer to purchase an insurance cash flow asset and accepts the offer. The seller then transfers ownership of the insurance asset cash flow to the investor via a true sale.

One embodiment comprises: means for arranging to sell an insurance asset cash flow to an investor; and means for transferring ownership of the insurance asset cash flow to the investor via a true sale.

Another embodiment comprises: means for obtaining ownership of a reinsurance asset from a prior owner; means for arranging to sell the reinsurance asset cash flow to an investor; means for transferring ownership of the insurance asset cash flow to the investor via a legal true sale, wherein the true sale (i) comprises a passing, from the seller to the investor, of all beneficial rights, title and interest in and to the insurance asset cash flow, (ii) produces an off-balance sheet result for the seller from an accounting perspective, and (iii) may permit the investor to directly assert a legal right against the prior owner; and means for receiving from the investor payment of a purchase price in exchange for the reinsurance asset cash flow.

Another embodiment comprises: means for arranging to purchase an insurance asset cash flow from a seller; and means for obtaining ownership of the insurance asset cash flow from the seller via a true sale.

Still another embodiment comprises: means for offering to sell an insurance asset cash flow to an investor; means for receiving from the investor an acceptance of the offer; and means for transferring ownership of the insurance asset cash flow to the investor via a true sale.

Yet another embodiment comprises: means for receiving from an investor an offer to purchase an insurance asset cash flow; means for accepting the offer; and means for transferring ownership of the insurance asset cash flow to the investor via a true sale.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a transaction flow diagram according to some embodiments of the present invention.

FIG. 2 is a flow chart of a method performed by a seller to facilitate an insurance asset transaction according to some embodiments of the present invention.

FIG. 3 is a transaction flow diagram illustrating a transfer of a reinsurance asset cash flow according to one example of the present invention.

FIG. 4 is a transaction flow diagram illustrating a transfer of a retrocession asset cash flow according to another example of the present invention.

FIG. 5 is a block diagram of a transaction device according to an embodiment of the present invention.

FIG. 6 is a tabular representation of a portion of an insurance asset database according to an embodiment of the present invention.

FIG. 7 is a tabular representation of a portion of a transaction database according to an embodiment of the present invention.

FIG. 8 is a flow chart of a method of facilitating a reinsurance asset transaction according to some embodiments of the present invention.

FIG. 9 is a flow chart of a method performed by an investor according to some embodiments of the present invention.

FIGS. 10 and 11 are flow charts of methods of facilitating insurance asset transactions according to some other embodiments of the present invention.

### DETAILED DESCRIPTION

Embodiments of the present invention are associated with “insurance assets.” As used herein, the phrase “insurance asset” refers to any right, associated with one or more insurance policies, that may be transferred to an investor. An insurance asset may be, for example, a right to receive repayments or collections associated with an insurance policy. Note that a single insurance asset may be associated with a number of different insurance policies, and that different insurance policies may be associated with different policy holders. Moreover, an insurance asset may be associated with an premium payment from a policy holder, an investment product that has an insurance component, a reinsurance asset, and/or a retrocession asset.

Moreover, embodiments of the present invention are associated with transferring ownership of an insurance asset via a “true sale.” As used herein, the phrase “true sale” may refer to, for example, a transfer of all beneficial rights, title, and interest in and to receivables associated with an insurance asset from a legal and accounting perspective. That is, upon payment of a purchase price, the true sale may be effective to pass full beneficial title to the receivables from the seller to the investor and to remove the receivables from the books of the seller from an accounting perspective.

Note that a true sale does not take effect as an assignment of those receivables—instead, the seller may hold its interest in those receivables subject to a constructive or resulting trust of which the investor is the beneficiary. As a result, a true sale of receivables may be binding on creditors of the seller (and on any liquidator, examiner, or receiver of the seller) and may not be set aside pursuant to local laws, courts, and/or regulations (e.g., US or UK laws). That is, the transfer would not be re-characterized as a loan from the investor to the seller secured by the receivables (e.g., because an appropriate court or government agency would not seek to re-characterize an agreement as a security arrangement where the agreement is an accurate record of the genuine agreement and intention of the parties and where the arrangement provided for by the agreement is not by nature a security agreement).

Transaction Flow Diagram

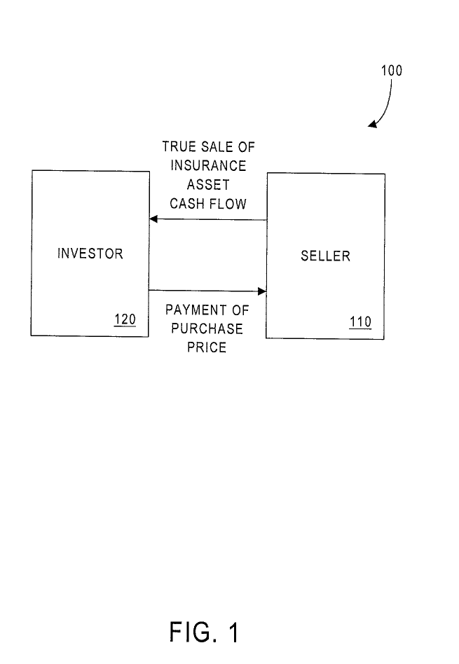

Turning now in detail to the drawings, FIG. 1 is a transaction flow diagram 100 according to some embodiments of the present invention. As can be seen, a seller 110 transfers ownership of an insurance asset cash flow to an investor 120 via a true sale. For example, the seller 110 may be a reinsurance entity that transfers ownership of insurance receivables to a bank via a true sale. In order to qualify as a “true sale,” the transaction may need to comply with one or more true sale requirements, such as legal and/or regulatory requirements that are applicable in one or more jurisdictions.

For example, the terms of the transaction (e.g., the language used in one or more agreement documents or contracts) may be such that a third party law firm will be able to issue a “true sale opinion.”, In addition, a professional accounting firm may issue a Financial Accounting Standard (FAS) true sale opinion in accordance with one or more statements of position from the Financial Accounting Standards Board, which provides accounting guidance on various topics.

For example, a true sale opinion may analyze the transaction in accordance with FAS 140 (“Accounting for Transfers and Servicing of Financial Assets and Extinguishments of Liabilities”), which governs whether financial assets transferred in securitization transactions should be treated as sales or secured financings for accounting purposes (e.g., depending on whether the transferred assets have been legally isolated, or placed “presumptively beyond the reach of the transferor and its creditors, even in the event of bankruptcy or insolvency”). Note that another issue addressed by FAS 140 is the sufficiency of legal opinions needed to support the conclusion that control of assets has been effectively relinquished by the transferor, which may be necessary for that transfer to be treated as a true sale for accounting purposes.

In exchange for the insurance asset cash flow, the investor 120 provides payment of a purchase price to the seller 110. The payment may comprise, for example, a lump-sum payment, a promise of one or more payments, and/or any other type of monetary or non-monetary payment.

Because the insurance asset cash flow is transferred from the seller 110 to the investor 120 via a legal and accounting true sale, the transaction may have an off-balance sheet result (e.g., an asset associated with the transaction should be removed from the seller's balance sheet after the sale). Moreover, the investor 120 may be able to directly assert a legal right against a prior owner of the insurance asset (e.g., an insurance company).

Transaction Method

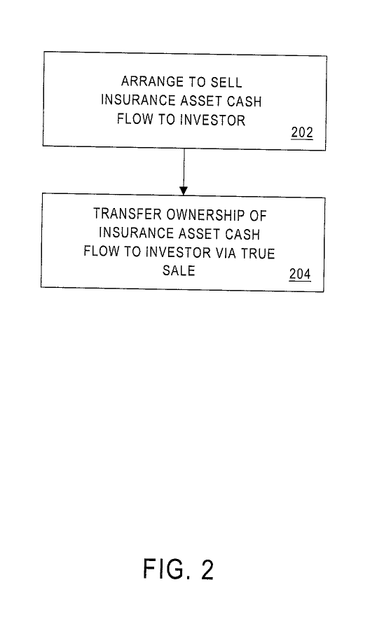

FIG. 2 is a flow chart of a method performed by a seller to facilitate an insurance asset transaction according to some embodiments of the present invention. The flow charts in FIG. 2 and the other figures described herein do not imply a fixed order to the steps, and embodiments of the present invention can be practiced in any order that is practicable.

At 202, a party arranges to sell an insurance asset cash flow to an investor. For example, a seller may identify and obtain the insurance asset and negotiate a sale of the insurance asset cash flow to one or more investors. According to one embodiment, the seller comprises a reinsurance entity and the insurance asset cash flow comprises a reinsurance asset cash flow. According to another embodiment, the seller comprises a reinsurance entity and the insurance asset cash flow comprises a retrocession asset cash flow. According to still another embodiment, the seller comprises an insurance entity.

The investor may comprise, for example, a bank or a bank syndicate. According to other embodiments, however, the investor may instead comprise a mutual fund, a commercial paper conduit, or any other entity.

Note that the insurance asset may be associated with a plurality of insurance policies, each insurance policy being associated with different policy holders. For example, the insurance asset may comprise a pool of investment products having an insurance component, each investment product being associated with a premium payment from a policy holder.

At 204, ownership of the insurance asset cash flow is transferred to the investor via a legal and accounting true sale. For example, the true sale may comprise a passing, from the seller to the investor, of all beneficial rights, title, and interest in and to receivables associated with the insurance asset.

Moreover, the true sale may produce an off-balance sheet result for the seller and let the investor directly assert a legal right against a prior owner of the insurance asset (e.g., an insurance entity or a reinsurance entity). According to some embodiments, the seller also obtains an opinion from a third party (e.g., a law firm and/or an accounting firm) indicating that the transfer is in accordance with one or more true sale requirements (e.g., FAS 140).

The seller may further receive from the investor payment of a purchase price in exchange for the insurance asset cash flow. In addition, the seller may receive repayments (e.g., insurance receivables) from a prior owner of the insurance asset and transfer those repayments to the investor. According to one embodiment, the sale of the insurance asset from the seller to the investor is performed on a revolving basis (e.g., an insurance asset cash flow associated with a pool of new insurance policies may be transferred each month).

Transaction Examples

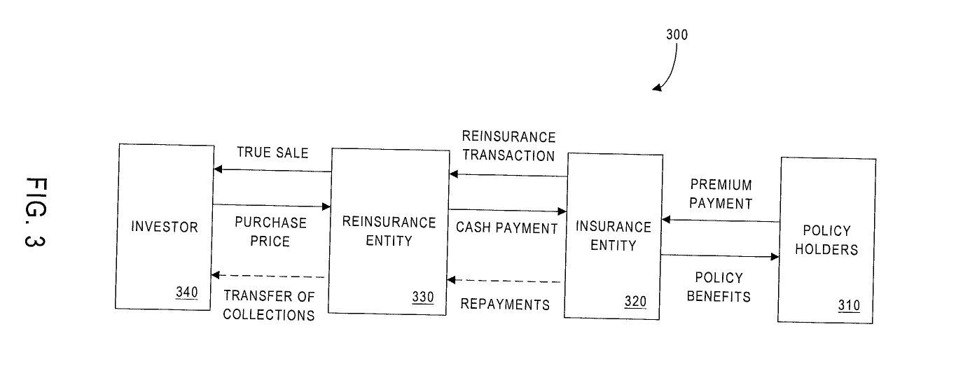

FIG. 3 is a transaction flow diagram 300 illustrating a transfer of a reinsurance asset cash flow according to one example of the present invention. Initially, an insurance entity 320 (e.g., an insurance company) sells an insurance product to policy holders 310. The insurance product may comprise, for example, a life product that has both an investment component and a life insurance component. Because of the life insurance component, the insurance product may receive favorable income and/or capital gain tax treatment in some jurisdictions.

To purchase the insurance product, the policy holder 310 may make a payment, referred to herein as a premium, to the insurance entity 320. The insurance entity 320 may, for example, invest some or all of the premium (e.g., for the benefit of the policy holder 310). The insurance entity 320 may also receive some type of compensation as part of the transaction. For example, the insurance entity 320 may collect an administration charge (e.g., a pre-determined amount or percentage of an invested premium). The insurance entity 320 may instead participate in investment profit (e.g., by retaining some or all of any excess return over a minimum guaranteed amount or index) and/or retain some or all of any residual funds that remain after all policy benefit payments have been made.

If the policy holder dies, his or her estate receives the value of the policy benefit payment on the date of death increased by, for example, a predetermined amount or percentage (this is the insurance component of the product, which may create tax benefits for the policy holder and/or the estate).

A reinsurance entity 330 then enters into a standard reinsurance transaction with the insurance entity 320. In particular, the insurance entity 320 enters into a separate contract with the reinsurance entity 330 in return for a cash payment, the contract providing certain rights and obligations associated with a pool of insurance products. Such a reinsurance transaction may be structured, for example, as a revolving facility through which the reinsurance entity 330 enters into similar contracts on a monthly basis.

Quarterly repayments from the insurance entity 320 to the reinsurance entity 330 are then made over a pre-determined period. The repayments may comprise, for example, contractual payments plus any early redemption accelerated payments of administration charges less any mortality-related waivers of administration charges.

According to the present invention, the reinsurance entity 330 then transfers rights to the reinsurance asset cash flow (e.g., the right the monthly receivables) to an investor 340 (e.g., a bank or a bank syndicate) via a true sale transaction. In exchange for the reinsurance asset cash flow, the investor 340 provides payment of a purchase price to the reinsurance entity 330.

Because the reinsurance asset cash flow was transferred via a legal and accounting true sale transaction, the asset may be removed from the balance sheet of the reinsurance entity 330 (e.g., freeing up the amount of capital the reinsurance entity 330 may use for other purposes). Moreover, the investor 340 may assert its rights to payment directly against the insurance entity 320. Also note that the insurance entity 320 may not be involved in the true sale transaction. As a result, the reinsurance entity 330 may not need to obtain permission from the insurance entity 320, the identity of the investor 340 might be withheld from the insurance entity 320, and/or the identity of the insurance entity 320 might be withheld from the investor 340.

Even after the true sale, the reinsurance entity 330 may still act as an agent for the investor 340. For example, the reinsurance entity 330 may act as a collection agent, a custodian, a trustee, and/or a reporting agent in exchange for an arm's length fee. In the case of a collection agent, the obligations of the reinsurance entity 330 may include: (i) transferring all collections received from the insurance entity 0.320 to the investor 340, net fees due to the reinsurance entity 330 under the agreement; (ii) netting repayments against the proceeds of the sale of new insurance assets, if any; and (iii) providing the investor 340 with a monthly report outlining the pool's performance. Of course, any of the these functions may instead be handled by a third-party.

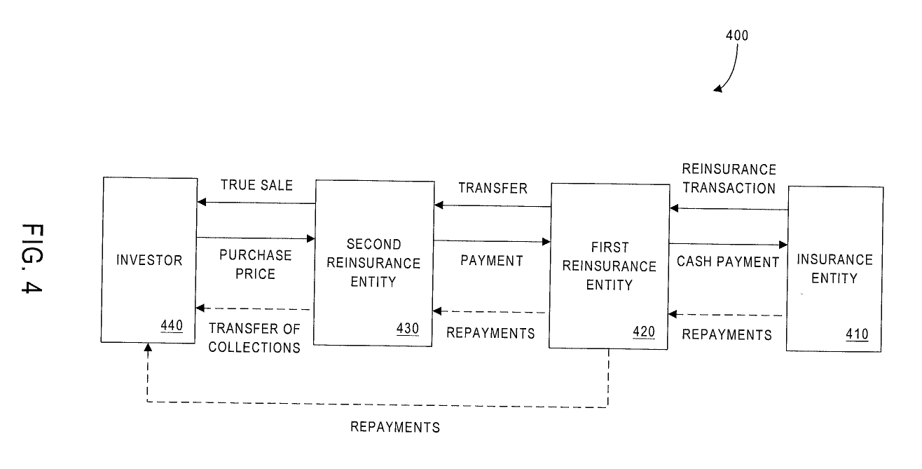

FIG. 4 is a transaction flow diagram 400 illustrating a transfer of a retrocession asset cash flow according to another example of the present invention. As before, an insurance entity 410 (e.g., an insurance company) sells an insurance product to policy holders (e.g., an insurance product similar to the product described with respect to FIG. 3).

A first reinsurance entity 420 then enters into a typical reinsurance transaction with the insurance entity 410. In particular, the insurance entity 410 enters into a contract with the reinsurance entity 420 in return for a cash payment, the contract providing certain rights and obligations with respect to a pool of insurance products.

Yearly repayments from the insurance entity 410 to the first reinsurance entity 420 are then made over a ten year period. The repayments may comprise, for example, contractual payments plus any early redemption accelerated payments of administration charges less any mortality-related waiver of administration charges. The insurance entity 410 may also be charged interest according to some embodiments.

According to the present invention, the first reinsurance entity 420 then transfers rights to the reinsurance asset (e.g., rights to the monthly receivables) to a second reinsurance entity 430. This transfer may comprise, for example, a typical retrocession transaction or a true sale. In exchange for what is now a retrocession asset, the second reinsurance entity 430 provides a payment to the first reinsurance entity 420. The second reinsurance entity 430 in turn transfers the retrocession asset cash flow via a true sale transaction to an investor 440, such as a bank syndicate. In exchange for the retrocession asset cash flow, the investor 440 provides payment of a purchase price to the second reinsurance entity 430.

The second reinsurance entity 430 may then act as an agent in exchange for an arm's length fee. That is, repayments may be transferred from the first reinsurance entity 420 to the investor 440 via the second reinsurance entity 430. According to another embodiment, the investor 440 instead receives repayments directly from the first reinsurance entity 420.

Transaction Device

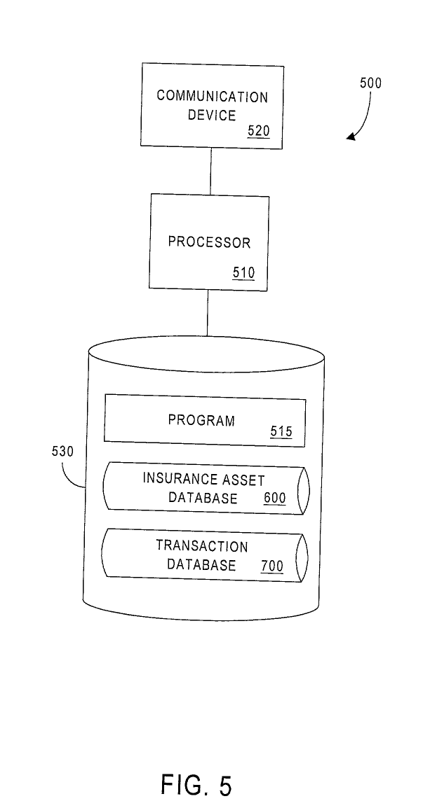

FIG. 5 illustrates a transaction device 500 that may be associated with, for example, the seller 110 and/or the investor 120 shown in FIG. 1. The transaction device 500 includes a processor 510, such as one or more INTEL® Pentium® processors. The processor 510 is coupled to a communication device 520 adapted to communicate via a communication network (not shown in FIG. 5). The communication network may be, for example, a Local Area Network (LAN), a Metropolitan Area Network (MAN), a Wide Area Network (WAN), a proprietary network, a Public Switched Telephone Network (PSTN), a wireless network, and/or an Internet Protocol (IP) network such as the Internet, an intranet, or an extranet.

When the transaction device 500 is associated with a seller, the communication device 520 may be used to communicate, for example, with an investor device (e.g., a bank's server) and/or a device associated with a prior owner of an insurance asset (e.g., an insurance company's server). When the transaction device 500 is associated with an investor, the communication device 520 may be used to communicate, for example, with a seller device (e.g., a reinsurance company's server).

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 stores a program 515 for controlling the processor 510. The processor 510 performs instructions of the program 515, and thereby operates in accordance with the present invention. When the transaction device 500 is associated with a seller, the processor 510 may help to arrange a sale of an insurance asset cash flow to an investor and/or facilitate a transfer of ownership of the insurance asset cash flow to the investor via a true sale (e.g., by generating documents and/or recording information associated with the transaction).

According to another embodiment, the processor 510 helps to arrange to obtain ownership of a reinsurance asset from a prior owner and also arranges to sell the reinsurance asset cash flow to an investor. The processor 510 then facilitates a transfer of ownership of the insurance asset cash flow to the investor via a true sale, wherein the true sale (i) comprises a passing, from the seller to the investor, of all beneficial rights, title and interest in and to the insurance asset cash flow, (ii) produces an off-balance sheet result for the seller, and (iii) lets the investor directly assert a legal right against the prior owner. The processor 510 may also help to arrange to receive from the investor payment of a purchase price in exchange for the reinsurance asset cash flow. The processor 510 may also handle a transfer of repayments from a prior owner to the investor.

When the transaction device 500 is associated with an investor, the processor 510 may help to arrange a purchase of an insurance asset cash flow from a seller and/or facilitate a receipt of ownership of the insurance asset cash flow from the seller via a true sale (e.g., by generating documents and/or recording information associated with the transaction).

As used herein, information may be “received” by or “transmitted” to a software application or module within the transaction device 500 from another software application, module, or any other source.

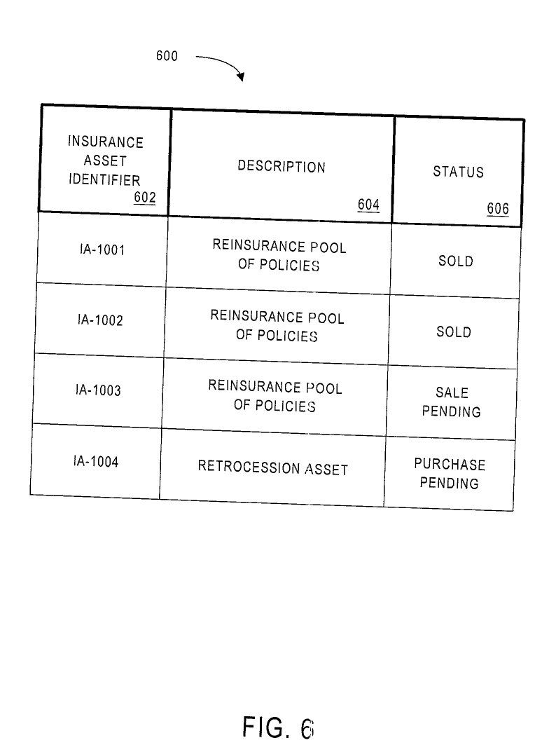

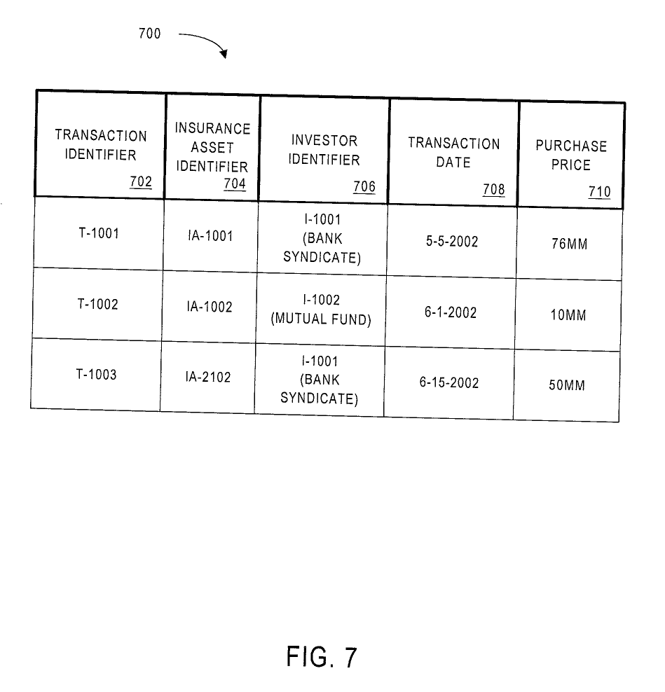

As shown in FIG. 5, the storage device 530 also stores an insurance asset database 600 (described with respect to FIG. 6) and a transaction database 700 (described with respect to FIG. 7). Examples of databases that may be used in connection with the transaction device 500 will now be described in detail. The illustrations and accompanying descriptions of the databases presented herein are exemplary, and any number of other database arrangements could be employed besides those suggested by the figures.

Insurance Asset Database

Referring to FIG. 6, a table represents the insurance asset database 600 that may be stored at the transaction device 500. The table includes entries identifying insurance asset cash flows that have been, or will be, transferred in accordance with the present invention. The table also defines fields 602, 604, 606 for each of the entries. The fields specify: an insurance asset identifier 602, a description 604, and a status 606. The information in the insurance asset database 600 may be created and updated, for example, based on information received from a prior owner of an insurance asset, a seller, and/or an investor.

The insurance asset identifier 602 may be, for example, an alphanumeric code associated with a particular insurance asset cash flow that has been, or will be, transferred in accordance with the present invention. The description 604 describes the insurance asset (e.g., indicating whether the insurance asset is a reinsurance asset or a retrocession asset). The status 606 reflects the current state of the insurance asset (e.g., indicating whether the insurance asset has been sold or purchased in accordance with the present invention).

Other information may also be stored in the insurance asset database 600. For example, a sale price or a purchase price, a transaction date, a seller identifier, and/or an investor identifier may be stored in the insurance asset database 600.

Transaction Database

Referring to FIG. 7, a table represents the transaction database 700 that may be stored at the transaction device 500. The table includes entries identifying true sale transactions that have been executed in accordance with the present invention. The table also defines fields 702, 704, 706, 708, 710 for each of the entries. The fields specify: a transaction identifier 702, an insurance asset identifier 704, an investor identifier 706, a transaction date 708, and a purchase price 710. The information in the transaction database 700 may be created and updated, for example, based on information received from a seller and/or an investor.

The transaction identifier 702 may be, for example, an alphanumeric code associated with a particular true sale transaction that was executed in accordance with the present invention.

The insurance asset identifier 704 indicates the insurance asset that was transferred and may be based on, or associated with, the insurance asset identifier 602 stored in the insurance asset database 600. The investor identifier 706 indicates the entity that purchased the insurance asset. The transaction date 708 and purchase price 710 indicate the date the insurance asset was sold and the amount of the payment that was provided in exchange for the insurance asset, respectively.

Other information may also be stored in the transaction database 700. For example, a link to a true sale opinion and/or an indication of one or more jurisdictions associated with the transaction may be stored in the transaction database 700.

Additional Transaction Methods

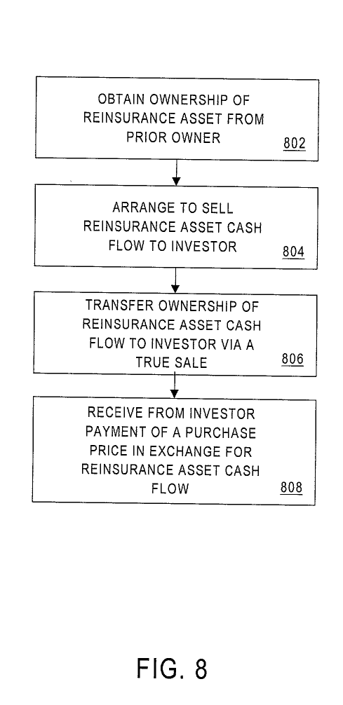

FIG. 8 is a flow chart of a method of facilitating a reinsurance asset transaction according to some embodiments of the present invention. At 802, ownership of a reinsurance asset is obtained from a prior owner. For example, a seller may obtain ownership of the reinsurance asset from an insurance entity. An indication of the reinsurance asset may then be stored in the insurance asset database 600.

At 804, it is arranged to sell the reinsurance asset cash flow to an investor. For example, the seller may negotiate with the investor to arrange for the sale of the reinsurance asset cash flow. At 806, ownership of the reinsurance asset cash flow is transferred to the investor via a true sale. For example, the seller may transfer ownership of the reinsurance asset cash flow to the investor via a true sale and update the transaction database 700 accordingly. The true sale may comprise, for example, a passing, from the seller to the investor, of all beneficial rights, title, and interest in and to the reinsurance asset cash flow. As a result, the true sale may produce an off-balance sheet result for the seller from an accounting perspective and/or let the investor directly assert a legal right against the prior owner.

At 808, payment of a purchase price is received from the investor in exchange for the reinsurance asset cash flow. For example, the seller may receive payment of the purchase price from the investor and update the transaction database 700 accordingly.

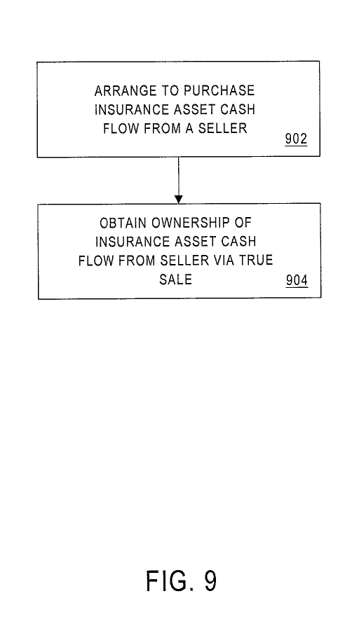

FIG. 9 is a flow chart of a method that may be performed by an investor according to some embodiments of the present invention. At 902, the investor arranges to purchase an insurance asset cash flow from a seller. For example, the investor may negotiate with the seller to arrange for the purchase of the insurance asset cash flow. At 904, the investor obtains ownership of the insurance asset cash flow from the seller via a true sale. For example, the investor may provide payment of a purchase price to the seller and obtain ownership of the insurance asset cash flow (e.g., ownership of insurance receivables).

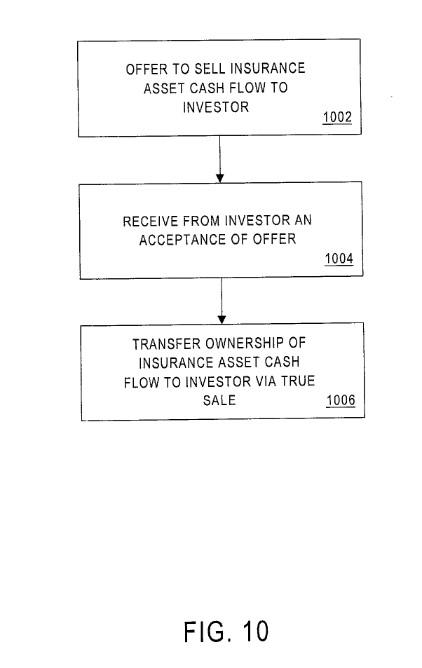

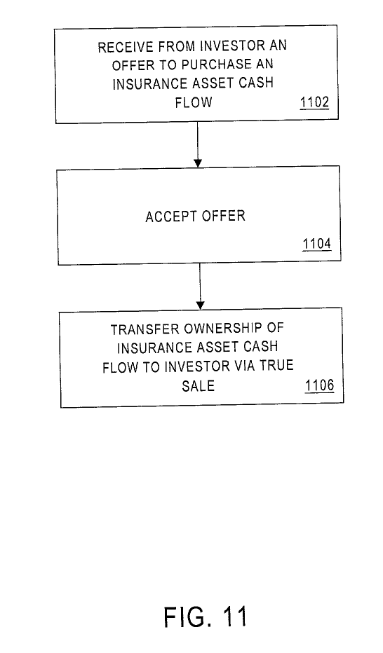

FIGS. 10 and 11 are flow charts of methods of facilitating insurance asset transactions according to some other embodiments of the present invention. As described herein, a seller may arrange to sell an insurance asset cash flow to an investor. As shown in FIG. 10, such arranging may comprise providing an offer to sell the insurance asset cash flow to the investor at 1002. After an acceptance is received from the investor at 1004, ownership of the insurance asset cash flow is transferred to the investor via a true sale at 1006.

As shown in FIG. 11, the seller may instead receive from an investor an offer to purchase an insurance asset cash flow at 1102. After the seller accepts the offer at 1104, ownership of the insurance asset cash flow is transferred to the investor via a true sale at 1106.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although some embodiments of the present invention have been described with respect to particular true sale requirements (e.g., FAS 140), the present invention is of course applicable even if these requirements are updated and/or replaced.

Similarly, although embodiments have been described with respect to particular types of insurance assets, the present invention can be used with other types of insurance assets as well. For example, the insurance asset may comprise “facultative” reinsurance (e.g., reinsurance transacted on an individual basis). That is, the insurance entity may have the option to offer an individual risk to the reinsurance entity while the reinsurance entity retains the right to accept or reject the risk. Similarly, the insurance asset may comprise “treaty” reinsurance (e.g., a transaction encompassing a block of the insurance company's book of business). In this case, the reinsurance entity must accept all business included within the terms of the reinsurance contract.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method performed by a seller to facilitate an insurance asset transaction, comprising:
arranging to sell an insurance asset cash flow to an investor; and
transferring ownership of the insurance asset cash flow to the investor via a true sale.

2. The method of claim 1, wherein the seller comprises a reinsurance entity and the insurance asset cash flow comprises a reinsurance asset cash flow.

3. The method of claim 1, wherein the seller comprises a reinsurance entity and the insurance asset comprises a retrocession asset cash flow.

4. The method of claim 1, wherein the seller comprises an insurance entity.

5. The method of claim 1, wherein the investor comprises at least one of: (i) a bank, (ii) a bank syndicate, (iii) a mutual fund, (iv) a commercial paper conduit, and (v) an insurance company.

6. The method of claim 1, wherein the true sale comprises a passing, from the seller to the investor, of all beneficial rights, title, and interest in and to the insurance asset cash flow.

7. The method of claim 1, wherein the true sale produces an off-balance sheet result for the seller from an accounting perspective.

8. The method of claim 1, further comprising:
prior to said transferring, obtaining ownership of the insurance asset from a prior owner.

9. The method of claim 8, wherein the prior owner comprises at least one of: (i) an insurance entity, and (ii) a reinsurance entity.

10. The method of claim 8, wherein said transferring lets the investor directly assert a legal right against the prior owner.

11. The method of claim 1, further comprising:
obtaining at least one of: (i) a legal opinion and (ii) an accounting opinion, the opinion indicating that said transferring is in accordance with at least one true sale requirement.

12. The method of claim 1, wherein the insurance asset is associated with a plurality of insurance policies, each insurance policy being associated with a policy holder.

13. The method of claim 1, wherein each insurance policy is associated with a premium payment from a policy holder.

14. The method of claim 1, wherein said transferring is performed on a revolving basis.

15. The method of claim 1, further comprising:
receiving from the investor payment of a purchase price in exchange for the insurance asset cash flow.

16. The method of claim 1, further comprising:
receiving repayments from a prior owner of the insurance asset; and
transferring the repayments to the investor.

17. A computer-implemented method performed by a seller to facilitate a reinsurance asset transaction, comprising:
obtaining ownership of a reinsurance flow from a prior owner;
arranging to sell the reinsurance asset cash flow to an investor;
transferring ownership of the insurance asset cash flow to the investor via a legal and accounting true sale, wherein the true sale (i) comprises a passing, from the seller to the investor, of all beneficial rights, title and interest in and to the insurance asset cash flow, (ii) produces an off-balance sheet result for the seller from an accounting perspective, end (iii) lets the investor directly assert a legal right against the prior owner; and
receiving from the investor payment of a purchase price in exchange for the reinsurance asset cash flow.

18. An apparatus, comprising:
a processor; and
a storage device in communication with said processor and storing instructions adapted to be executed by said processor to:
arrange to sell an insurance asset cash flow to an investor, and
transfer ownership of the insurance asset cash flow to the investor via a true sale.

19. The apparatus of claim 18, wherein said storage device further stores at least one of: (i) an insurance asset database, and (ii) a transaction database.

20. The apparatus of claim 18, further comprising:
a communication device coupled to said processor and adapted to communicate with at least one of: (i) a seller device, (ii) an investor device, (iii) an insurance entity device, and (iv) a reinsurance entity device.

21. A medium storing instructions adapted to be executed by a processor to perform a method of facilitating an insurance asset transaction, said method comprising:
arranging to sell an insurance asset cash flow to an investor; and
transferring ownership of the insurance asset cash flow to the investor via a true sale.

22. A method performed by an investor to facilitate an insurance asset transaction, comprising:
arranging to purchase an insurance asset cash flow from a seller; and
obtaining ownership of the insurance asset cash flow from the seller via a true sale.

23. A method performed by a seller to facilitate an insurance asset transaction, comprising:
offering to sell an insurance asset cash flow to an investor;
receiving from the investor an acceptance of the offer; and
transferring ownership of the insurance asset cash flow to the investor via a true sale.

24. A method performed by a seller to facilitate an insurance asset transaction, comprising:
receiving from an investor an offer to purchase an insurance asset cash flow;
accepting the offer; and
transferring ownership of the insurance asset cash flow to the investor via a true sale.
